(19) United States
(12) Patent Application Publication
(10) Pub. No.: US 2026/0362284 A1
(43) Pub. Date: Nov. 12, 2026

(54) WTRU-INITIATED WITHDRAWAL FROM FEDERATED LEARNING OPERATION

(71) Applicant: INTERDIGITAL PATENT HOLDINGS, INC., Wilmington, DE (US)

(72) Inventors: Jung Je Son, Warrington, PA (US); Ulises Olvera-Hernandez, Saint-Lazare (CA); Morteza Kheirkhah, London (GB); Zhibi Wang, Woodridge, IL (US); Alec Brusilovsky, Downingtown, PA (US); Guanzhou Wang, Brossard (CA); Aneeqa Ijaz, Tulsa, OK (US); Achref Methenni, Montreal (CA)

(73) Assignee: INTERDIGITAL PATENT HOLDINGS, INC., Wilmington, DE (US)

(21) Appl. No.: 19/102,092

(22) PCT Filed: Aug. 9, 2023
(86) PCT No.: PCT/US2023/029868

§ 371 Date: Feb. 7, 2025

Related U.S. Application Data
(60) Provisional application No. 63/396,488, filed on Aug. 9, 2022.

(51) Int. Cl. H04W 40/12; H04W 24/02

(52) U.S. Cl. CPC H04W 40/12; H04W 24/02

(57) ABSTRACT

Methods and apparatuses for initiating withdrawal from a federated learning operation are provided herein. Methods implemented in a wireless transmit receive unit may include: receiving a routing selection policy that includes a background data transfer (BDT) policy; determining that the WTRU cannot meet a requirement of the BDT policy and indicating the WTRU's inability to meet the requirement of the BDT policy. The indication may be by transmitting a status report; transmitting a mobility registration that does not include network slice selection assistance information for an application associated with the BDT policy; releasing a protocol data unit session associated with the BDT policy; or by application layer signaling to an application function associated with the BDT policy.

### CROSS-REFERENCE TO RELATED APPLICATIONS

This application claims the benefit of U.S. Provisional Patent Application No. 63/396,488, filed Aug. 9, 2022, the contents of which are incorporated herein by reference.

### BACKGROUND

A WTRU operating in a Fifth Generation (5G) communications system may participate in a Federated Learning operation. The WTRU may be operating in a communications system having a radio access network (RAN) with 5G radio access technology (RAT) or Evolved Universal Mobile Telecommunications System (UMTS) Terrestrial Radio Access (E-UTRA) and that connects to a NextGen core network (CN). An Access Control and Mobility Management Function (AMF) may provide the system with the following functionalities: Registration management, Connection management, Reachability management, and/or Mobility Management. A Session Management Function (SMF) may provide the system with the following functionalities: session management (including session establishment, modify and release), WTRU IP address allocation, and/or selection and control of UP function. A User plane function (UPF) may provide the system with the following functionalities: packet routing & forwarding, packet inspection, and/or traffic usage reporting.

### SUMMARY

Methods and apparatuses for initiating withdrawal from a federated learning operation are provided herein. A method implemented in a WTRU may include: receiving a routing selection policy that includes a background data transfer (BDT) policy; determining that the WTRU cannot meet a requirement of the BDT policy: indicating the WTRU's inability to meet the requirement of the BDT policy by one of: transmitting a status report; transmitting a mobility registration that does not include network slice selection assistance information for an application associated with the BDT policy; releasing a protocol data unit session associated with the BDT policy; or by application layer signaling to an application function associated with the BDT policy.

In a further aspect the requirement of the BDT policy is a requirement to provide data in a timeframe set by the BDT policy. In a further aspect, the determination of inability to meet the BDT policy requirement is based on detection of a change in quality of service. In a further aspect the determination of inability to meet the BDT policy requirement is based on power consumption. In a further aspect the status report may include a reason for the WTRU's inability to meet the requirement of the BDT policy. In a further aspect the reason may be related to a change in service area of the WTRU. In a further aspect, the reason may be related to a user change to a configuration of the WTRU. In a further aspect, the WTRU may receive an updated routing selection policy after indicating the WTRU's inability to meet the requirement of the BDT policy. In a further aspect, a WTRU may be configured to perform any one of the above-described methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a signaling flow diagram illustrating an exemplary procedure for WTRU status reporting for a URSP policy update.

FIG. 3 is a signaling flow diagram illustrating an exemplary procedure for providing a WTRU status update based on URSP rules when requesting to establish or modify a PDU session;

FIG. 4 is a signaling flow diagram showing an exemplary procedure for providing a WTRU's status update for network slice availability

FIG. 5 is a signaling flow diagram illustrating event exposure on WTRU's slice availability by the AMF;

FIG. 6 is a signaling flow diagram illustrating an exemplary procedure for providing a WTRU status update via a PDU session;

FIG. 7 is a signaling flow diagram illustrating an exemplary procedure by which a WTRU status update is performed via the application layer; and

FIG. 8 is a signaling flow diagram illustrating an exemplary procedure for providing FL analytic assistance by WTRU status update report.

### DETAILED DESCRIPTION

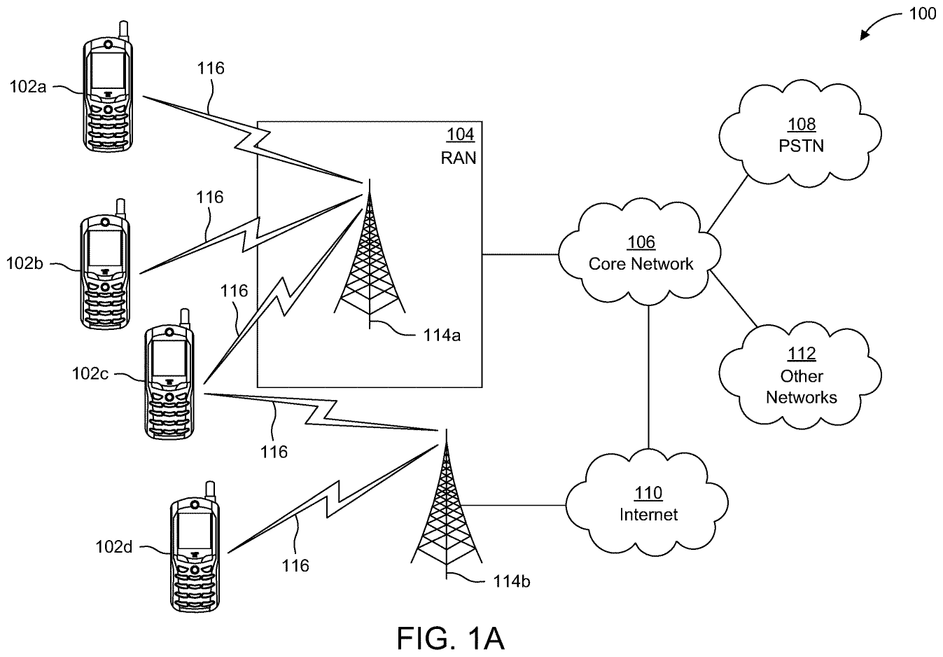

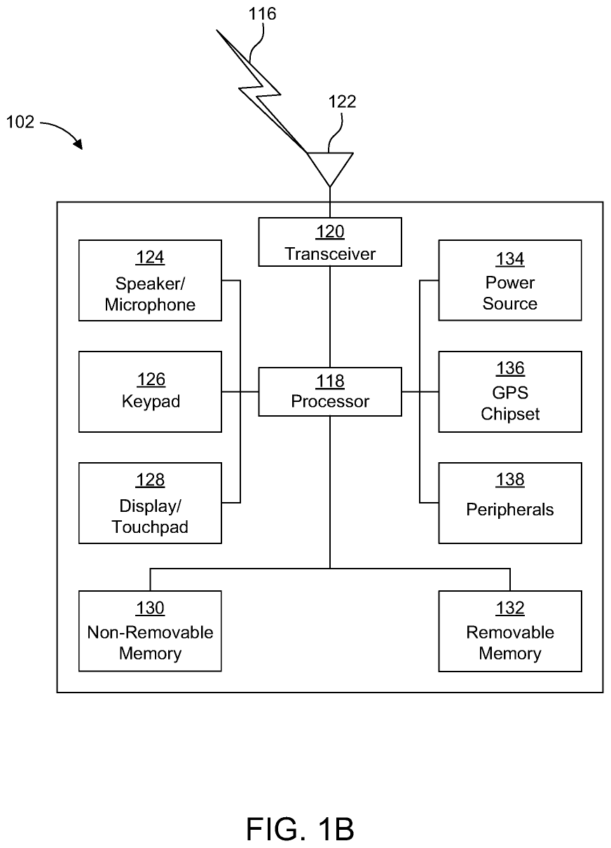

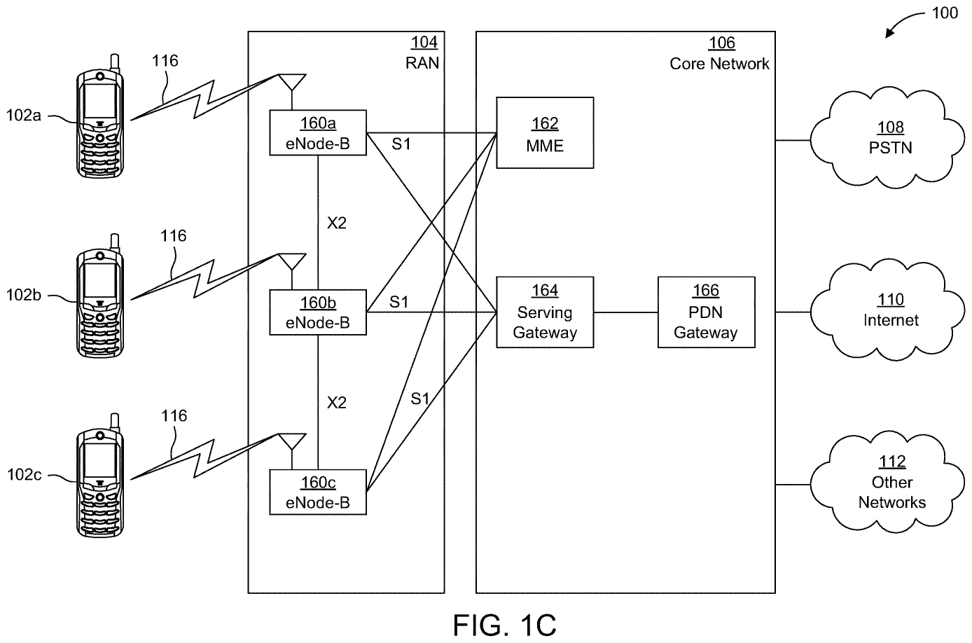

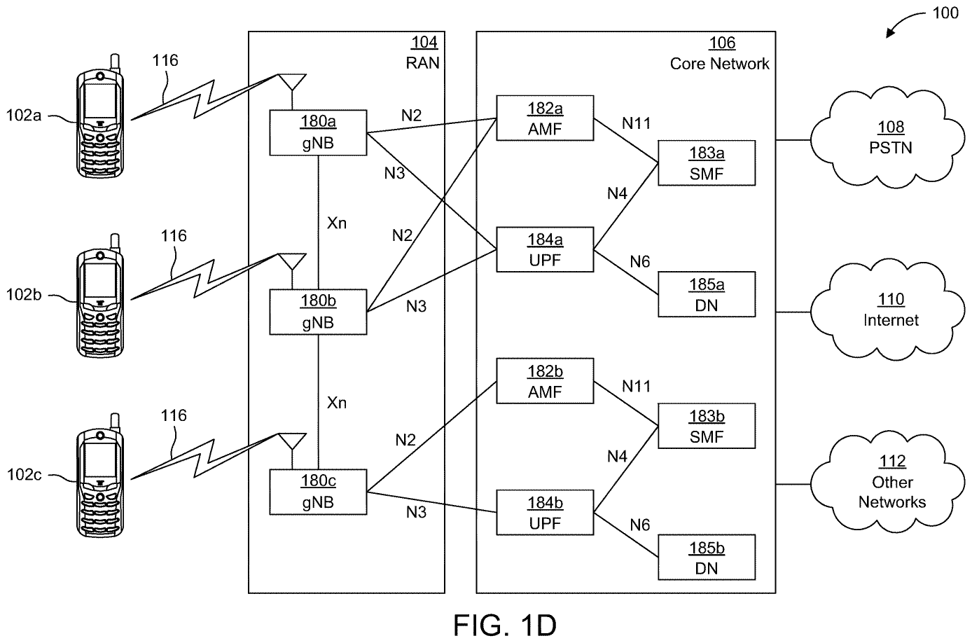

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Table 1 is a listing of acronyms as may be used herein:

TABLE 1
Acronyms

| | |
|---|---|
| AMF | Access and Mobility Function |
| AN | Access Network |
| AR | Augmented Reality |
| AS | Application Server |
| CN | Core Network |
| DL | Downlink |
| D2D | Device-to-Device |
| DN | Data Network |
| DNN | Data Network Name |
| DNAI | Data Network Access Identifier |
| DPI | Deep Packet Inspection |
| DSCP | Differentiated Services Code Point |
| ECN | Explicit Congestion Notification |
| FEC | Forward Error Correction |
| GPSI | Generic Public Subscription Identifier |
| ID | Identifier |
| IE | Information Element |
| IP | Internet Protocol |
| L4S | Low Latency, Low Loss, Scalable Throughput Internet |
| | Service |
| LADN | Local Area Data Network |
| LAN | Local Area Network |
| LSB | Least Significant Bits |
| MSB | Most Significant Bits |
| NAS | Non-Access Stratum |
| NEF | Network Exposure Function |
| NSSAI | Network Slice Selection Assistance Information |
| NSSRG | Network Slice Simultaneous Registration Group |
| NWDAF | Network Data Analytics Function |
| OAM | Operations Administration and Maintenance |
| PCC | Policy Charging and Control |
| PCF | Policy Control Function |
| PDU | Protocol Data Unit |
| PDR | Packet Detection Rule |
| PER | Packet Error Rate |
| ProSe | Proximity Services |
| PSA | PDU Session Anchor |
| QFI | QoS Flow Identifier |
| QoS | Quality of Service |
| QoE | Quality of Experience |
| RAN | Radio Access Network |
| RAT | Radio Access Technology |
| SDF | Service Data Flow |
| SMF | Session Management Function |
| SSC | Session and Service Continuity |
| SSID | Service Set Identifier |
| S-NSSAI | Single NSSAI |
| TLV | Type-Length-Value |
| UE | User Equipment |
| UL | Uplink |
| UCI | Uplink Control Information |
| UPF | User Plane Function |
| URSP | UE/WTRU Route Selection Policy |
| VN | Virtual Network |
| WTRU | Wireless Transmit/Receive Unit |
| VR | Virtual Reality |
| XR | Extended Reality |
| XRM | Extended Reality and Media (Services) |

Network slicing considerations are described herein. Restrictions may be imposed for simultaneous registrations of network slices. A WTRU may support subscription-based restrictions to simultaneous registration of network slices. When an AMF provides configured NSSAI to the WTRU, and the WTRU indicated it supports the feature, the AMF may provide the WTRU with the NSSRG information related to the S-NSSAls of the home public land mobile network (HPLMN), which may be included in the mapping information of the configured NSSAI. When the WTRU receives NSSRG values in the network slicing configuration information, the WTRU may include in the requested NSSAI the S-NSSAIs that share a common NSSRG as per the received information.

When a network changes the NSSRG information in the subscriber record, the network may update the WTRU with the new NSSRG information, providing the WTRU with slicing configuration information by means of the WTRU configuration update procedure. These updates may bring changes in the configured NSSAI and in the allowed NSSAI.

Slice-specific admission control is described herein. The Network Slice Admission Control (NSAC) feature may enable operators to manage and control the number of registered WTRUs per network slice and/or the number of PDU sessions per network slice for the network slices that are configured to support NSAC. A Network Slice Admission Control Function (NSACF) may be responsible for monitoring and controlling WTRUs and PDU sessions admitted to a specific network slice.

As a WTRU moves across a network, and the network is configured with multiple service areas, handled by specific NSACFs, it may be possible that a WTRU that was previously admitted in a service area controlled by, e.g., the NSACF-A, the same WTRU may not be admitted in a contiguous service area which slice admission control is now handled by a different NSACF, e.g., NSACF-B.

Network Data Analytics statistics and predictions are described herein. The Network Data Analytics feature may provide statistics and/or predictions based on specific requests from the entities consuming this information. Some examples of the type of information that the feature is capable of providing, includes statistics and predictions on network node status information, network node resource usage, communication and mobility performance in an area of interest. The target of such analytics may include a single WTRU, a group of WTRUs or any WTRU that may be in an area of interest. Furthermore, network data analytics may be provided to characterize network function load, and/or network slice load, as well as data analytics that can provide predictions and statistics regarding WTRU mobility, expected WTRU behavior and even observed service experience at multiple levels, including network slice, service experience for a particular application or service experience for a particular application over a particular access type (RAT type or frequency).

Future background data transfer is described herein. The procedure for future background data transfer may enable the negotiation between an AF (application function) and a network (i.e., a PCF) about the transfer policies for the future background data transfer. An application service provider (ASP) may negotiate with the network a time window and related conditions for future background data transfer (BDT), including network area information where BDT may take place, and optionally an aggregated bitrate. The ASP may do this either through an AF that communicates directly via the PCF (Policy Control Function) or through the NEF (Network Exposure Function). This negotiation may take place before the WTRU establishes a PDU session.

When the AF wants to apply the BDT policy to a future session, it may provide the Network with a background data transfer reference ID together with an external identifier (i.e. GPSI) or external group. A PCF serving WTRUs targeted by this request, may retrieve the BDT policy or may receive a notification by subscribing to WTRU Application Data changes. The PCF then sends related BDT polices to the WTRU by creating a UE/WTRU Routing Selection Policy (URSP) and sending it to the WTRU.

When the PCF needs to update the URSP rule related to the BDT policy, the PCF may trigger the WTRU configuration update procedure. The WTRU may use the route selection validation criteria to determine whether or not a PDU Session should be established.

When the PDU Session is established, the PCF that serves the PDU Session may use the BDT reference ID in the WTRU's PDU session policy control subscription information to retrieve the corresponding BDT policy and the related information from the UDR and derives the Policy Charging and Control (PCC) rule for the BDT.

The PCF may subscribe to analytics on network performance from the NWDAF for the area of interest and time window of a BDT policy. If, for instance, the PCF becomes aware that network performance degrades below some threshold values, the PCF may try to re-negotiate the affected BDT policies with application functions (AFs) that accepted BDT policy re-negotiation.

Various problems addressed by the proposed embodiments are described herein. Various existing solutions suggest time dependent configuration of traffic descriptors. These solutions may rely on network driven configuration of URSP rules which should be followed by the WTRU. A problem with such solutions may be that there is no standardized way to enable WTRUs to determine whether the user wants to participate in sessions configured by the network or to signal the network whether it is capable of doing it. In some cases, it may not be possible for the WTRU to participate in a future schedule data session, such as when sending background traffic or sending traffic with different QoS at different times.

Some problems addressed herein may relate to mobility across service areas with NSSRG restrictions or tracking area (TA). A network may update the NSSRG information, e.g., when a WTRU changes service area and this triggers a mobility registration. If this is the case, it is possible that a network slice associated to e.g., an application federating learning operation is removed from the allowed NSSAI as it would conflict with other network slices as indicated in the NSSRG information. This may prevent the WTRU from reporting any local training for the application FL operation where the network slice is running and therefore it should be excluded from the FL members.

Some problems addressed herein may relate to mobility across service areas with a congested network. The network may update the admission control information for a network slice, e.g., as the WTRU moves across service areas handled by different NSACFs. Thus, it is possible that a WTRU that was previously admitted in a service area controlled by NSACF-A may no longer be admitted when it moves to a service area now controlled, for example, by NSACF-B. In this case, it is possible that the network slice associated to e.g., to an application federating learning operation cannot be used in the next service area. This may prevent the WTRU from reporting any local training for the application FL operation where the network slice is running and therefore it should be excluded from the FL members

It should be noted that similar issues can occur when the WTRU changes RA (Registration Area) and the new RA no longer supports the network slice over which the application AIML operation is running. Furthermore, service area restrictions may also impose limitations.

Some problems addressed herein may relate to cases where a WTRU moves to a service area with suboptimal conditions. If the WTRU is moving towards a service area where performance is likely to degrade, network congestion may be experienced or the observed service experience may be suboptimal, and it may be unfavorable to include a WTRU in FL operation while the WTRU remains in a service area with suboptimal conditions. The network may provide statistics and predictions regarding specific network conditions, however this information may not be available to the WTRU.

Some problems addressed herein may concern resource utilization for a WTRU's AIML operation. In some scenarios, the network and AIML AF may cooperate for better AIML operation and as per AIML AF, the network may manage network resources to guarantee proper AIML operation and may also involve the WTRU by using an URSP update to the potential member of FL operation. There may be no way to inform the network when the WTRU cannot perform operation as expected, however, and this may induce waste of reserved resources.

Some problems addressed herein may relate to limitations on WTRU battery power. When there are limitations on WTRU battery power, the system may need to optimize battery life by closing several services in the WTRU with some criteria e.g. high power consumption apps, non-essential apps, low priority apps, etc. This may induce rejection or withdrawal of some service which WTRU is involved in and release any corresponding network resource.

Some problems addressed herein may concern user configuration changes. While using an application in the WTRU, a user may want to change a WTRU configuration based on the user's taste and it may induce closing or dropping a service involved and release of any corresponding network resource.

Various solutions addressing at least the above-described problems are provided herein.

If a WTRU detects any of the scenarios described substantially above, based on the time window allocated by the AF for local model transfer/training reporting, the WTRU may determine whether it wants/is able to report interim training results within the allocated time window. In embodiments, the WTRU may communicate its intent with the 5G Network e.g., through WTRU status reporting for a URSP policy, by mobility registration that does not include the S-NSSAI where the application AIML operation is running, by releasing an AIML-related PDU session, or by letting an AF contact the network.

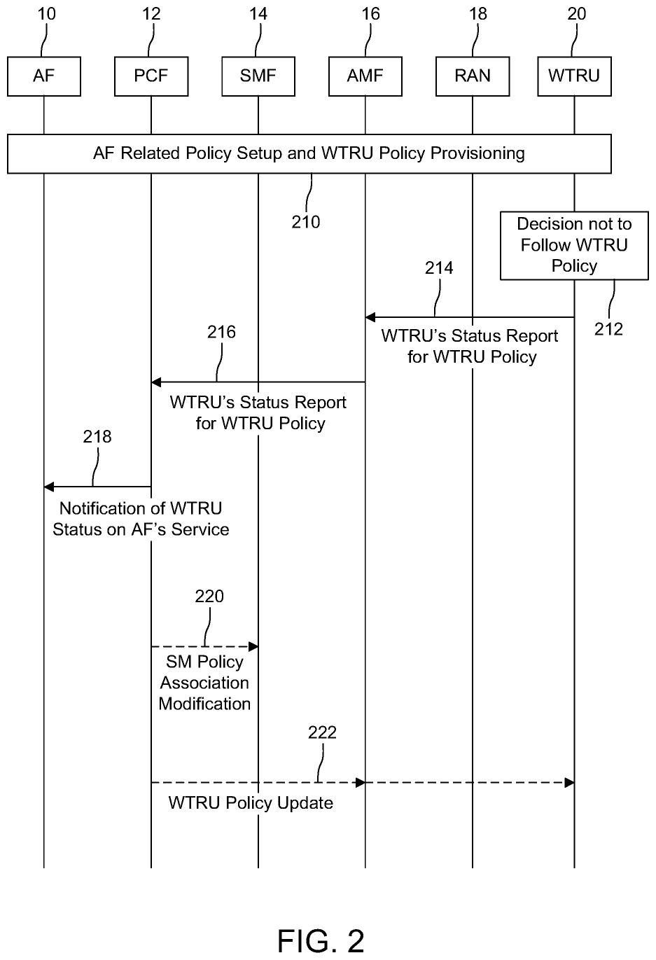

FIG. 2 is a signalling flow diagram illustrating an exemplary procedure for WTRU status reporting for a URSP policy update. FIG. 2 shows and AF 10, PCF 12, SMF 14, AMF 16, RAN 18 and WTRU 20. At 210 of an exemplary procedure, per an AF's request, PCF 12 and AF 10 negotiated policy setting for the application may be requested by the AF 10. If needed, the PCF 12 may setup a BDT policy also for future background data transmission for the application and reserve resources to guarantee proper communication service for the application with a group of WTRUs as requested by the AF. For BDT policy, the PCF 12 may update a URSP rule with validation criteria (e.g. time window and location) for each WTRU which is included as a candidate WTRU for the policy setting per AF request.

At 212, after being updated with the URSP rule, for any reason including the cases stated above, a WTRU 20 may determine that the WTRU may not proceed with the future PDU session in the time window or location indicated by the validation criteria or that the WTRU should drop from the AF's 10 service. At 214, after deciding the WTRU cannot proceed with the future PDU session, WTRU may send to the AMF 16 a WTRU status report for the WTRU policy which includes indication that WTRU cannot follow some URSP rule. WTRU may include relating URSP rule info such as URSP rule ID which is indicated that WTRU cannot follow and relating service info such as application identifier, traffic descriptor, or other information which may identify the service which the indicated URSP rule is associated. WTRU may include the reason for the indication, for example it can be sub-optimal for reasons stated substantially in paragraphs above. This indication of the reason why WTRU is withdrawing from following the URSP rule can assist the network in determining or inferring the cause and the best course of actions to adopt. At 216, when the AMF 16 receives WTRU's 20 status report toward PCF, the AMF 16 may forward the WTRU's status report to the PCF 12.

At 218, after receiving the WTRU's status report, the PCF 12 may identify relating policy such as BDT policy, session management related policy from the included relating service info. The PCF 12 may inform the AF 10, directly when the AF is trusted or via NEF when AF is untrusted as it is outside of 5G network, relating to the application that the WTRU shall be dropped from the service traffic. For example, in FL service, the WTRU may be dropped from the candidate list of WTRUs for FL service. Alternatively, or additionally, the AF may ask modification of BDT policy, e.g. modification of validation rule.

At 220 if the SMF 14 was configured for the session management information relating to the application for the WTRU e.g. QoS rule relating information, the PCF 12 may update an SM policy to release the QoS rule relating to the application for the WTRU. Alternatively, or additionally, if the PCF 12 received modification of BDT policy, the PCF 12 may update the SM policy according to the received modification request.

At 222, based on the WTRU's status report, the PCF 12 may update URSP rules for the WTRU, e.g. removing URSP rules for the application, updating URSP rules for the application such as modification of validation rule such as time condition and location condition. The PCF 12 may send a WTRU policy update to the WTRU 20 via the AMF 16.

Solutions involving updates to URSP rules with conditions for best operation are described herein. Additionally or alternatively, a 5G CN may provide the URSP with updated conditions for best operation to the WTRU.

An updated condition for best operation may be the recommended value for providing best operation to the WTRU. It may include a recommended WTRU battery level, channel condition such as minimum SINR, minimum CINR, or other value, recommended location and timing i.e. to avoid traffic in overloaded or bad traffic conditions, etc.

When WTRU determines that a WTRU's environment does not satisfy the conditions for best operation on WTRU policy, WTRU may send WTRU's status report for the WTRU policy according to one or more of the steps described above.

A 5GCN may manage session management policies with conditions for best operation in association with the URSP with updated conditions for best operation. When a 5GCN receives a WTRU's PDU session establishment, the 5GCN may check session management policies whether it has conditions for best operation.

When the requested PDU session does not satisfy the conditions for best operation of the relating session management policy, a 5GCN may reject the PDU session request for serving other PDU sessions in priority or better conditions. The decision from the 5GCN may depends on various circumstances.

Solutions involving updates to the URSP based on policy control request triggers are described herein.

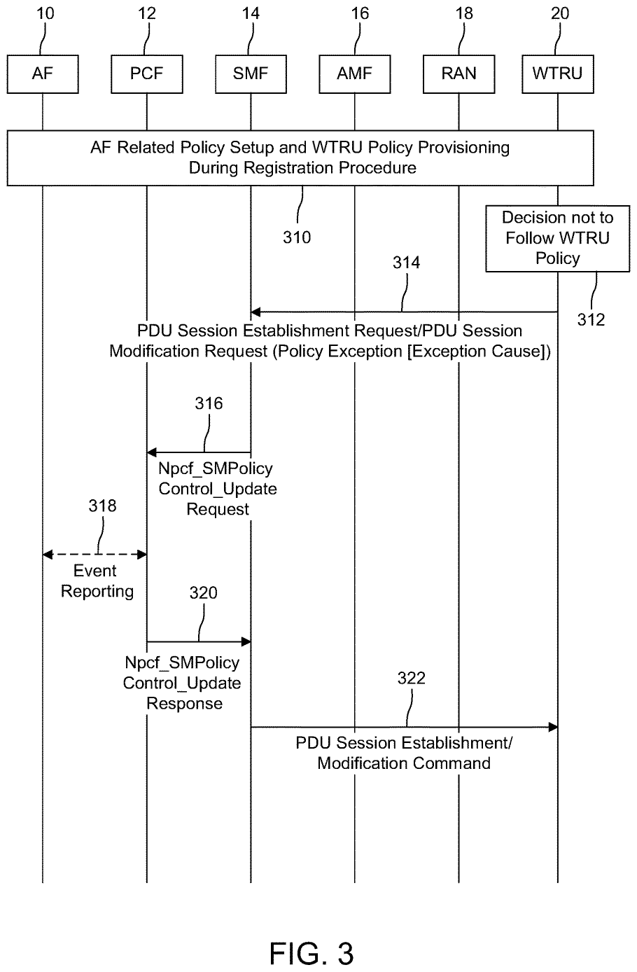

FIG. 3 is a signaling flow diagram illustrating an exemplary procedure for providing a WTRU status update based on URSP rules when requesting to establish or modify a PDU session. At 310, per an AF's 10 request, the PCF 12 and AF 10 may have a negotiated policy setting for the application requested by the AF 10. If needed, the PCF 12 may set up policies that apply within a time window, for example, future application specific traffic that requires reserved resources to guarantee proper communication service for the application with a group of WTRUs as requested by the AF 10.

At 312 after the WTRU has been updated with URSP rules, and based on one or more conditions as specified herein, the WTRU 20 may determine to trigger the establishment of a new PDU Session or a PDU Session modification request, indicating that for certain policies and at a specific time window, a location or AN type, WTRU may not fulfill certain WTRU (session or mobility management) policies and therefore the WTRU may not be suitable for a service managed at the AF 10. At 314, after deciding what policies cannot be met during a specific time window, time or AN type, the WTRU 10 may include the status report within the PDU session establishment or modification request to the SMF. At 316, the SMF 14 may initiate a policy association modification procedure, if a policy control trigger is met. In this case, the WTRU notification that certain URSP rules cannot be fulfilled may be a condition that satisfies the policy control request trigger. At 318 the PCF 12 may report this policy change, based on an AF 10 subscription to such an event. At 320, based on the SMF inputs, the PCF 12 may provide the updated policy information to the SMF. At 322, the SMF may include the new policy information in the PDU session establishment accept/modification command message.

Solutions relating to WTRU mobility registration updates with network slice configurations are described herein.

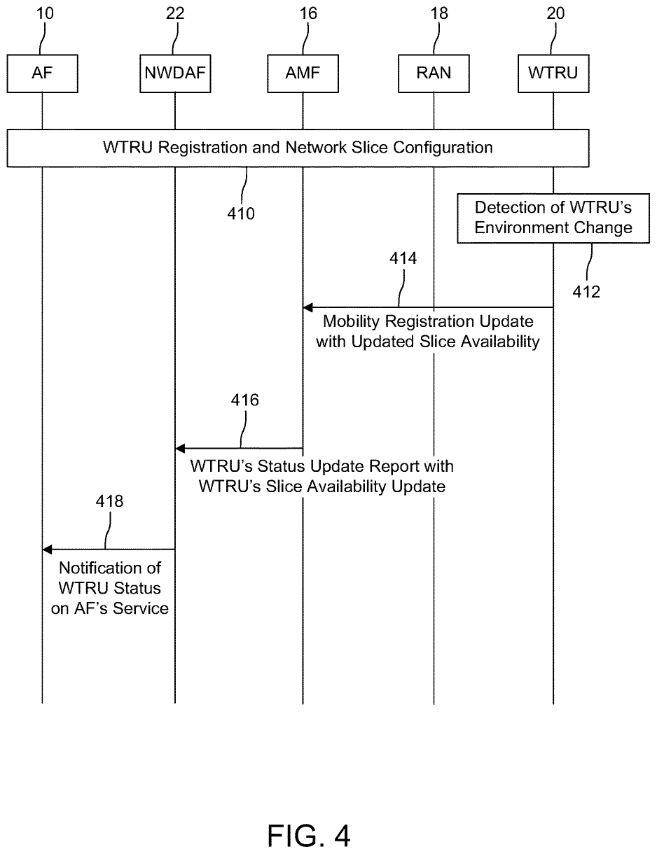

FIG. 4 is a signaling flow diagram showing an exemplary procedure for providing a WTRU's status update for network slice availability. At 410 per an AF's 10 request, a 5G network may have negotiated with the AF for related policy setting and network slice configuration for the application requested by the AF 10. For example, when a WTRU 20 enrolled in a FL operation, the WTRU may be configured on the network slice for exchanging traffic for the FL operation.

At 412, according to WTRU mobility or other environment changes, the WTRU 20 may detect that the WTRU will be available or unavailable to use the network slice for the AF 10 which may be configured as a result of the preceding step described above. For example, when a WTRU 20 is configured with a network slice for FL operation and other network slice which belongs to different NSSRG, the WTRU 20 may move to a different RA in which network slice belongs to different NSSRG from FL operation is available. For example, the WTRU 20 may newly enter the area in which the SNSSAI for the FL operation become unavailable.

At 414, after detecting the update to the availability of FL operation, the WTRU 20 may send a mobility registration request with intended S-NSSAIs to the AMF 16. For example, when FL operation unavailable within the WTRU, the WTRU may send S-NSSAls not including NSSAI for FL operation as requested S-NSSAIs.

At 416, after receiving a mobility registration request, when the AMF 16 detects that FL operation has become available or not available at the WTRU due to an update for network slice unavailability, AMF 16 may inform a NWDAF 22, PCF (not shown), NEF (not shown), or other NF (not shown) that subscribed at the AMF 16 earlier for notification of WTRU's status change that the WTRU's network slice environment has changed and the network slice for FL operation has become available or unavailable. For example, on behalf of the AF 10, the NEF may request notification service on WTRU's slice availability to the AMF. In this case after receiving a mobility registration, the AMF may inform an update of the WTRU's slice availability to the NEF, and the NEF may inform AF as follows, for example.

At 418, when the NWDAF 22 or other NF receives a WTRU's status change or a report on WTRU's slice availability update, it may inform the AF 10, directly when AF is trusted or via NEF when AF is untrusted as it is outside of 5G network, for FL operation that the WTRU become available or unavailable for FL operation.

Solutions relating to event exposure by the AMF as to the WTRU's slice usage are described herein.

When a WTRU requests changes of allowed network slices or changes to different NSSRG, an AMF may notify this change to the AF or other NF that is subscribed for notification on the WTRU's slice availability as part of the AMF's event exposure service.

A WTRU's slice availability may be determined based on whether allowed SNSSAIs of the WTRU have changed, whether a specific S-NSSAI information is included or excluded in the allowed NSSAI of the WTRU, and/or the information of allowed NSSAls in WTRU.

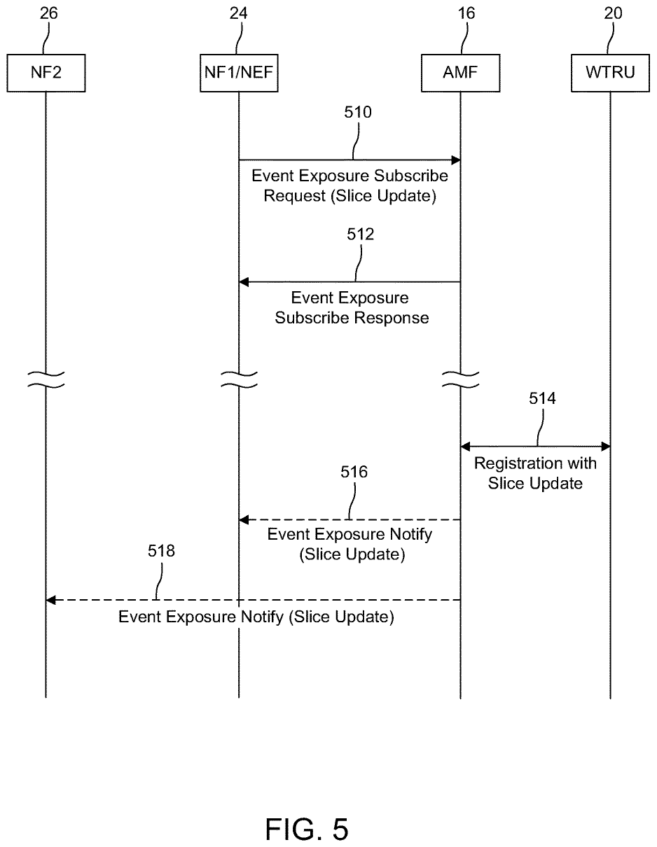

FIG. 5 is a signalling flow diagram illustrating event exposure on WTRU's 20 slice availability by the AMF 16. In one step of an exemplary procedure, an NF1 or NEF 24 may send a request to an AMF 16 to subscribe 510 to a set of Event ID(s) including Event ID for an WTRU's slice availability update in the AMF. When subscribing to the notification service, the NF1 or NEF 24 may request notification when a specific S-NSSAI value or group of S-NSSAI values become available or unavailable (i.e. when those values become included or excluded in allowed NSSAI of the WTRU). The NF other than NF1/NEF, e.g., NF2 26 as shown in FIG. 5, can be requested as the destination of the notification service in a subscription request from NF1/NEF and accepted by service provider NF, shown in FIG. 5 as the AMF 16. At 512, the AMF may acknowledge the execution of the subscription. At 514, the WTRU 20 may change the WTRU's requested NSSAI via registration procedure and AMF 16 may allow those requested NSSAI to allowed NSSAI in consideration of WTRU's subscription, availability of NFs supporting the requested NSSAI, and/or other parameters. At 516, when the AMF 16 detects that the WTRU's slice availability has changed, the AMF may send the event report to the notification end point which may include whether allowed NSSAI of the WTRU have changed, whether a specific S-NSSAI information is included or excluded in allowed NSSAI of the WTRU, and/or the information of allowed NSSAls in WTRU. When the notification end point is different from subscribed NF (i.e. NF1 or NEF), as shown at 518, the AMF 16 may send the event report to the NF2 26 which may include an indication whether allowed NSSAI of the WTRU has changed, whether a specific S-NSSAI information is included or excluded in allowed NSSAI of the WTRU, and/or the information of allowed NSSAI in WTRU.

Solutions relating to the release of AIML-related PDU session(s) are described herein.

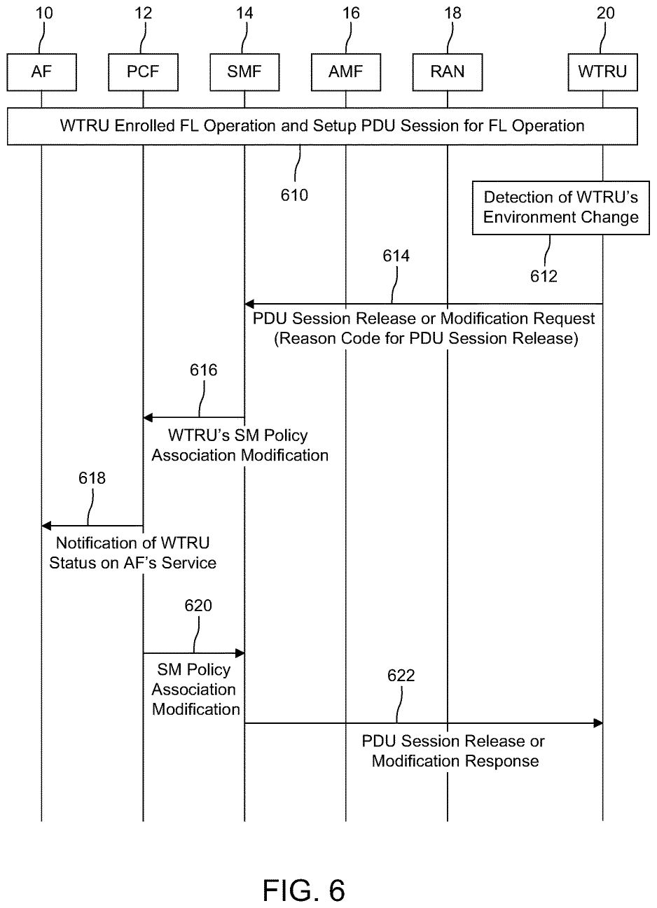

FIG. 6 is a signaling flow diagram illustrating an exemplary procedure for providing a WTRU status update via a PDU session. When a WTRU 20 is enrolled in a service for FL operation 610, the WTRU 20 may be configured with network slice information, DNN information, or other session relating subscription information for the FL operation and the WTRU may setup a PDU session for the FL operation. At 612, for any reason, the WTRU 20 may not maintain a PDU session for FL operation, or WTRU want to drop from FL operation. For example, this may occur when a WTRU has moved in a service area with suboptimal conditions, or when the WTRU encounters battery issues and may need to drop a service consuming a high degree of battery power. At 614 after detection of environment change, the WTRU 20 may send to the SMF 14 a PDU session release request or PDU session modification request to release the QoS flow for the FL operation. The WTRU may include the reason for release in the PDU session release request. For example, the WTRU 20 may include “withdrawal from FL operation” as a reason to notify that WTRU has withdrawn from FL operation. For example, the WTRU may include an indication of the cases as described above as reasons for the PDU session release to indicate WTRU's environment change. At 616, when the SMF 14 receives the PDU Session Release or PDU session modification, SMF 14 may contact PCF 12 to update SM policy association modification to drop the PDU session or QoS flow relating to FL operation. At 618 when receiving an indication of the WTRU's unavailability for FL operation or withdrawal from FL operation as reason for PDU session release or just based on receiving PDU session release, a PCF 12 or NWDAF (not shown) which is informed of WTRU's unavailability by PCF may notify the AF 10, directly when the AF is trusted or via NEF when the AF is untrusted as it is outside of the 5G network, relating to the FL operation that WTRU is not available anymore or WTRU want to withdraw from FL operation. At 620 the PCF 12 may respond to the SMF 14 with a SM policy association modification response. At 622, the SMF14 may respond to the WTRU in response to a PDU session release response or PDU session modification response and may include the result on the PDU session or QoS flow for the FL operation.

Solutions relating to providing notifications to the AIML service via the application layer are described herein.

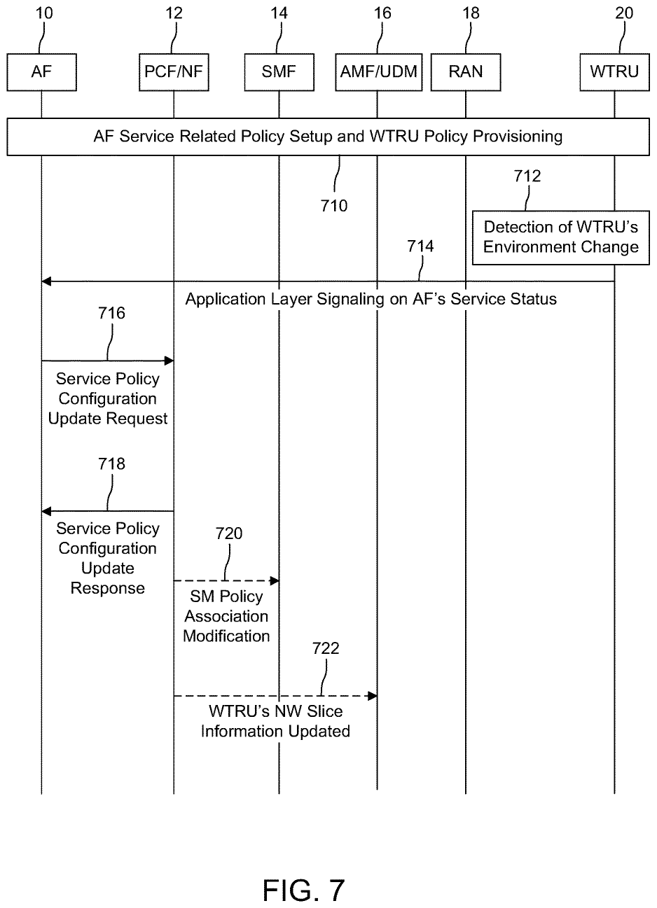

FIG. 7 is a signaling flow diagram illustrating an exemplary procedure by which a WTRU status update is performed via the application layer. At 710, per an AF's 10 request, the PCF 12 and AF 10 may negotiate policy settings for the application requested by the AF. If needed, the PCF may setup a BDT policy also for future background data transmission for the application and reserve resource to guarantee proper communication service for the application with group of WTRUs 20 as requested by the AF 10. For BDT policy, the PCF may update a URSP rule with validation criteria (e.g. time window and location) for each WTRU that is included as a candidate WTRU for the policy setting per AF request. When the AF's service is to be consumed at a network slice, the slice information will be configured at the WTRU during registration or a WTRU configuration update procedure. At 712, at some point, due to any reason including the cases described herein, the WTRU 10 may determine that it cannot maintain the service from the AF 10 or that the WTRU may need to withdraw or pause the service. At 714 the WTRU 20 may inform the WTRU's status update on AF's 10 service via application layer signaling. At 716, when receiving the WTRU's service status update, the AF 10 may negotiate with the PCF 12 or other NF in 5GCN, directly when the AF 10 is trusted or via the NEF when the AF is untrusted as it is outside of 5G network, to update the service policy configuration. For example, when a BDT policy has been setup for AF's service, AF may update WTRU list for BDT policy in order to remove the WTRU from the list. For example, when a network slice is used for the AF's service, as the WTRU does not use the AF's service anymore, the WTRU may be configured to remove the network slice for the AF's service. At 720, after receiving the request from the AF 10, the PCF 12 or other NF in the 5GCN may respond and update its policy or configuration with the SMF 14. At 722, based on the service policy configuration update, other NFs can be informed of the update. For example, when there is an ongoing PDU session for the AF's service, the SMF may be informed to release the PDU session. In some examples, the AMF 16, UDM, and/or NSSF (not shown) may be informed of the network slice information to be removed from the allowed NW slice and/or configured NW slice.

Solutions relating to providing federated learning analytics assistance by WTRU status update are described herein.

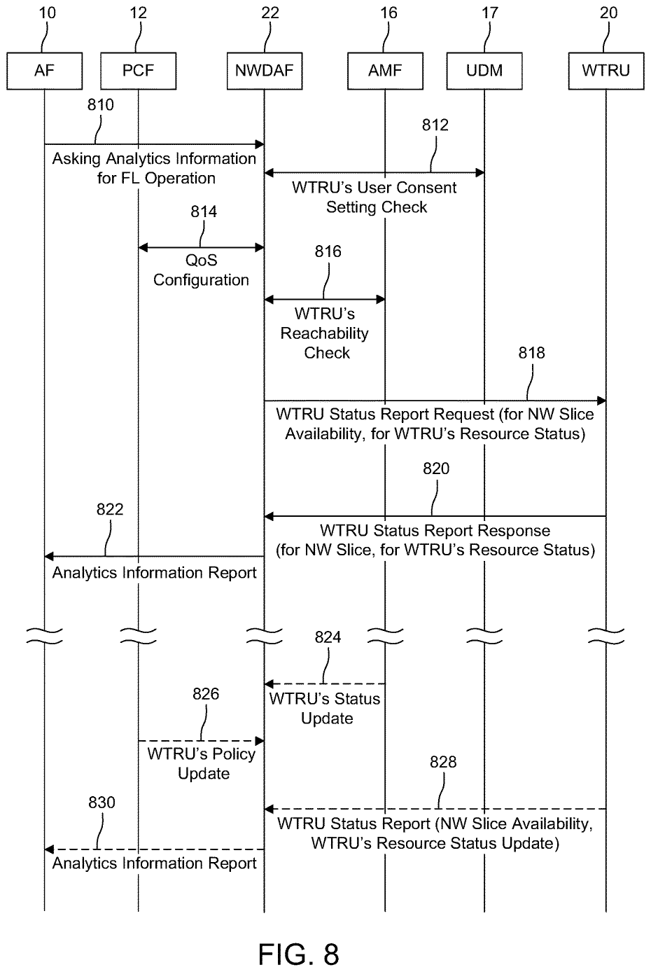

FIG. 8 is a signaling flow diagram illustrating an exemplary procedure for providing FL analytic assistance by WTRU status update report.

At 810, the AF 10 may request analytic information for potential FL members (e.g., candidate WTRU list or group of WTRUs). The AF may request NWDAF specific analytic information for each WTRU 20 such as WTRU mobility, WTRU latency or UL/DL data rate, etc., or the AF may request NWDAF 28 aggregated analytic information such as an aggregated bit rate, average delay of group, etc., directly when AF is trusted or via the NEF when the AF is untrusted as it is outside of 5G network. Alternatively, or additionally, the AF may communicate with an dedicated NF, for example an Al/ML assistance NF, to request assistance information for Al/ML operation for potential FL members, directly when AF is trusted or via the NEF when the AF is untrusted as it is outside of 5G network. After receiving a request from the AF, the dedicated NF may request NWDAF analytic information for each WTRU or aggregated analytic information.

At 812, based on a request, the NWDAF 22 may communicate with NFs such as a UDM 17, PCF, AMF, SMF or others to collect status information on the candidate WTRUs about requested analytics information. For example, the NWDAF 28 may contact the UDM 17 (as shown) to check the WTRU's 20 user consent setting on analytic information or WTRU's other information to the AF. For example, at 814 the NWDAF 28 may contact the PCF 12 to collect QoS or PDU session statistics on the candidate WTRUs. For example, the NWDAF may contact AMF to check the WTRU's reachability or other location or mobility related information. Based on the response from each NF, the NWDAF may compose analytic information for FL members.

At 818, the NWDAF 28 may request a WTRU's status report via the AMF 16 to the WTRU 20. The WTRU's status report may include a WTRU's slice availability (e.g., a list of allowed NSSAls), the WTRU's resource status such as battery power consumption, and/or the WTRU's performance data such as data rate, error rate, delays etc. At 820, the WTRU may respond to the NWDAF 28 via the AMF 16 with the WTRU's status report. The NWDAF may compose analytic information for FL member based on WTRU's status report and response data from each NF. Based on the WTRU's status report, the NWDAF may determine whether the WTRU is available or a proper entity for AF's FL operation. At 822, after composing analytic data for FL members, the NWDAF 28 may respond to the AF 10 with analytic data.

Alternative or additionally (e.g., as part of one or more of the steps described above), the AF may subscribe to a notification service for any update on analytic information for potential FL members.

When receiving an analytic information notification update request, the NWDAF may subscribe to the notification service on each WTRU's status update which belongs to potential FL members to each NF or WTRU itself. The subscription may be performed during one or more of the steps described substantially above as a same procedure or additional procedure.

After successful subscription on notification service, when there is an update on WTRU's status detected from WTRU itself, the AMF, SMF, PCF, and/or other NF which NWDAF subscribed for notification, each NF may inform WTRU's status update. For example, similar to one or more of the solutions described herein, at 828 the WTRU may report the WTRU's environment change through the AMF 16 to the NWDAF 28. For example, similarly to one or more of the solutions described herein, at 824, the AMF 16 may report the WTRU's status update to the NWDAF 28 when the AMF receives mobility registration for WTRU mobility or for slice update.

After receiving an updated report from WTRU itself, the AMF, PCF 12 (shown here at 826), and/or other NF, at 830, the NWDAF 28 may inform the AF 10 of WTRU's 20 status update, directly when AF is trusted or via NEF when AF is untrusted as it is outside of the 5G network.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

1. A method implemented in a wireless transmit receive unit (WTRU) comprising:
receiving a request to participate in a learning operation, wherein the request includes a routing selection policy that includes a background data transfer (BDT) policy;
determining that the WTRU cannot meet a requirement of the BDT policy;
indicating inability of the WTRU to meet the requirement of the BDT policy by one of:
transmitting a status report;
transmitting a mobility registration that does not include network slice selection assistance information for an application associated with the BDT policy;
releasing a protocol data unit session associated with the BDT policy, or
signaling by an application layer to an application function associated with the BDT policy; and
indicating availability of interim data related to the learning operation.

2. The method of claim 1, wherein the requirement of the BDT policy is a requirement to provide data in a timeframe set by the BDT policy.

3. The method of claim 1, wherein the determination of inability to meet the BDT policy requirement is based on detection of a change in quality of service.

4. The method of claim 1, wherein the determination of inability to meet the BDT policy requirement is based on power consumption.

5. The method of claim 1, wherein the status report includes a reason for inability of the WTRU to meet the requirement of the BDT policy.

6. The method of claim 5, wherein the reason is related to a change in service area of the WTRU.

7. The method of claim 5, wherein the reason is related to a user change to a configuration of the WTRU.

8. The method of claim 1, further comprising receiving an updated routing selection policy after indicating inability of the WTRU to meet the requirement of the BDT policy.

9. A wireless transmit/receive unit (WTRU) configured to:
receive a request to participate in a learning operation, wherein the request includes a routing selection policy that includes a background data transfer (BDT) policy;
determine that the WTRU cannot meet a requirement of the BDT policy;
indicate inability of the WTRU to meet the requirement of the BDT policy by one of:
transmitting a status report;
transmitting a mobility registration that does not include network slice selection assistance information for an application associated with the BDT policy;
releasing a protocol data unit session associated with the BDT policy, or
signaling by application layer to an application function associated with the BDT policy; and
indicate availability of interim data related to the learning operation.

10. The WTRU of claim 9, wherein the requirement of the BDT policy is a requirement to provide data in a timeframe set by the BDT policy.

11. The WTRU of claim 9, wherein the determination of inability to meet the BDT policy requirement is based on detection of a change in quality of service.

12. The WTRU of claim 9, wherein the determination of inability to meet the BDT policy requirement is based on power consumption.

13. The WTRU of claim 9, wherein the status report includes a reason for inability of the WTRU to meet the requirement of the BDT policy.

14. The WTRU of claim 13, wherein the reason is related to a change in service area of the WTRU.

15. The WTRU of claim 13, wherein the reason is related to a user change to a configuration of the WTRU.

16. The WTRU of claim 9, wherein the WTRU is further configured to receive an updated routing selection policy after indicating inability of the WTRU to meet the requirement of the BDT policy.

17. The WTRU of claim 9, wherein the WTRU is further configured to transmit the interim data.

18. The method of claim 8, further comprising transmitting the interim data.
